(19) United States
(12) Patent Application Publication
(10) Pub. No.: US 2010/0015437 A1
(43) Pub. Date: Jan. 21, 2010

(54) TITANIUM DIOXIDE-CONTAINING COMPOSITE

(76) Inventors: Sonja Grothe, Bottrop (DE); Petra Fritzen, Duisburg (DE); Jochen Winkler, Rheurdt (DE); Bernd Rohe, Dinslaken (DE)

Correspondence Address: FULBRIGHT & JAWORSKI, LLP, 666 FIFTH AVE, NEW YORK, NY, 10103-3198, US

(21) Appl. No.: 12/438,595

(22) PCT Filed: Aug. 27, 2007
(86) PCT No.: PCT/EP07/58896

§ 371 Date: May 28, 2009

(30) Foreign Application Priority Data
Aug. 25, 2006 (DE) 102006039856.4

(51) Int. Cl. B32B 5/16; C08K 9/00

(52) U.S. Cl. 428/329; 523/205; 523/209

(57) ABSTRACT

Titanium dioxide-containing composites, methods for producing them and the use of the composites.

The invention provides a titanium-dioxide-containing composite, a method for its production and the use of this composite.

From the application of conventional fillers and pigments, also known as additives, in polymer systems it is known that the nature and strength of the interactions between the particles of the filler or pigment and the polymer matrix influence the properties of a composite. Through selective surface modification the interactions between the particles and the polymer matrix can be modified and hence the properties of the filler and pigment system in a polymer matrix, hereinafter also referred to as a composite. A conventional type of surface modification is the functionalisation of the particle surfaces using alkoxyalkylsilanes. The surface modification can serve to increase the compatibility of the particles with the matrix. Furthermore, a binding of the particles to the matrix can also be achieved through the appropriate choice of functional groups.

A second possibility for improving the mechanical properties of polymer materials is the use of ultrafine particles. U.S. Pat. No. 6,667,360 discloses polymer composites containing 1. to 50 wt. % of nanoparticles having particle sizes from 1 to 100 nm. Metal oxides, metal sulfides, metal nitrides, metal carbides, metal fluorides and metal chlorides are suggested as nanoparticles, the surface of these particles being unmodified. Epoxides, polycarbonates, silicones, polyesters, polyethers, polyolefines, synthetic rubber, polyurethanes, polyamide, polystyrenes, polyphenylene oxides, polyketones and copolymers and blends thereof are cited as the polymer matrix. In comparison to the unfilled polymer, the composites disclosed in U.S. Pat. No. 6,667,360 are said to have improved mechanical properties, in particular tensile properties and scratch resistance values.

A further disadvantage of the filler-modified composites described in the prior art is their inadequate mechanical properties for many applications.

An object of the present invention is to overcome the disadvantages of the prior art.

An object of the invention is in particular to provide a composite which has markedly improved values for flexural modulus, flexural strength, tensile modulus, tensile strength, crack toughness, fracture toughness, impact strength and wear rates in comparison to prior art composites.

Improved mechanical properties allow thinner components to be produced. This can make a decisive contribution to reducing weight in the automotive and aerospace sector. Applications include, for example, bumpers or interior trim in trains and aircraft made from thermoset moulding compositions. Adhesives require high tensile strength values above all. Applications for elastomeric plastics, based for example on polymers such as styrene-butadiene rubber (SBR), include inter alia seals and vibration dampers.

Surprisingly the object was achieved with composites according to the invention having the features of the main claim. Preferred embodiments are characterised in the sub-claims.

Surprisingly the mechanical and tribological properties of polymer composites were greatly improved even with the use of precipitated, surface-modified titanium dioxide having crystallite sizes d₅₀ of less than 350 nm (measured by the Debye-Scherrer method). Astonishingly, a physical bond between the particles and matrix has a particularly favourable effect on improving the mechanical and tribological properties of the composite.

The composite according to the invention contains a polymer matrix and 0.1 to 60 wt. % of precipitated titanium dioxide particles, with average crystallite sizes d₅₀ of less than 350 nm (measured by the Debye-Scherrer method). The crystallite size d₅₀ is preferably less than 200 nm, particularly preferably 3 to 50 nm. The titanium dioxide particles can have a spherical or bar-shaped morphology.

The composites according to the invention can also contain components known per se to the person skilled in the art, for example mineral fillers, glass fibres, stabilisers, process additives (also known as protective systems, for example dispersing aids, release agents, antioxidants, anti-ozonants, etc.), pigments, flame retardants (e.g. aluminium hydroxide, antimony trioxide, magnesium hydroxide, etc.), vulcanisation accelerators, vulcanisation retarders, zinc oxide, stearic acid, sulfur, peroxide and/or plasticisers.

A composite according to the invention can for example additionally contain up to 80 wt. %, preferably 10 to 80 wt. %, of mineral fillers and/or glass fibres, up to 10 wt. %, preferably 0.05 to 10 wt. %, of stabilisers and process additives (e.g. dispersing aids, release agents, antioxidants, etc.), up to 10 wt. % of pigment and up to 40 wt. % of flame retardant (e.g. aluminium hydroxide, antimony trioxide, magnesium hydroxide, etc.).

A composite according to the invention can for example contain 0.1 to 60 wt. % of titanium dioxide, 0 to 80 wt. % of mineral fillers and/or glass fibres, 0.05 to 10 wt. % of stabilisers and process additives (e.g. dispersing aids, release agents, antioxidants, etc.), 0 to 10 wt. % of pigment and 0 to 40 wt. % of flame retardant (e.g. aluminium hydroxide, antimony trioxide, magnesium hydroxide, etc.).

The polymer matrix can consist of an elastomer or a thermoset. Examples of elastomers are natural rubber (NR), isoprene rubber (IR), butyl rubber (CIIR, BIIR), butadiene rubber (BR), styrene-butadiene rubber (SBR), acrylonitrile-butadiene rubber (NBR), bromobutyl rubber (BIIR), styrene-butadiene-isoprene rubber (SBIR), chloroprene rubber (CR), chlorosulfonated polyethylene rubber (CSM), hydrogenated NBR rubber (HNBR), polymethylsiloxane-vinyl rubber (VMQ), acrylate-ethylene rubber (AEM), acrylate rubber (ACM), fluoro rubber (FKM), fluorosilicone rubber (FVMQ), thermoplastic elastomers (TPE), thermoplastic elastomers (TPE) based on polyamide (TPA), based on copolyesters (TPC), based on olefins (TPO), based on styrene (TPS), based on polyurethane (TPU), based on vulcanised rubber (TPV) or mixtures of at least two of these plastics. Suitable thermosets are, for example, unsaturated polyester resins (UP), phenolic resins, melamine resins, formaldehyde moulding compositions, vinyl ester resins, diallyl phthalate resins, silicone resins or urea resins. UP resins are particularly suitable thermosets.

The composite according to the invention can contain 0.1 to 60 wt. % of precipitated, surface-modified titanium dioxide, 0 to 80 wt. % of mineral fillers and/or glass fibres, 0.05 to 10 wt. % of stabilisers and process additives (e.g. dispersing aids, release agents, antioxidants, etc.), 0 to 10 wt. % of pigment and 0 to 40 wt. % of flame retardant (e.g. aluminium hydroxide, antimony trioxide, magnesium hydroxide, etc.).

According to the invention ultrafine titanium dioxide particles having an inorganic and/or organic surface modification can be used.

The inorganic surface modification of the ultrafine titanium dioxide typically consists of compounds containing at least two of the following elements: aluminium, antimony, barium, calcium, cerium, chlorine, cobalt, iron, phosphorus, carbon, manganese, oxygen, sulfur, silicon, nitrogen, strontium, vanadium, zinc, tin and/or zirconium compounds or salts. Sodium silicate, sodium aluminate and aluminium sulfate are cited by way of example.

The inorganic surface treatment of the ultrafine titanium dioxide takes place in an aqueous slurry. The reaction temperature should. preferably not exceed 50° C. The pH of the suspension is set to pH values in the range above 9, using NaOH for example. The post-treatment chemicals (inorganic compounds), preferably water-soluble inorganic compounds such as, for example, aluminium, antimony, barium, calcium, cerium, chlorine, cobalt, iron, phosphorus, carbon, manganese, oxygen, sulfur, silicon, nitrogen, strontium, vanadium, zinc, tin and/or zirconium compounds or salts, are then added whilst stirring vigorously. The pH and the amounts of post-treatment chemicals are chosen according to the invention such that the latter are completely dissolved in water. The suspension is stirred intensively so that the post-treatment chemicals are homogeneously distributed in the suspension, preferably for at least 5 minutes. In the next step the pH of the suspension is lowered. It has proved advantageous to lower the pH slowly whilst stirring vigorously. The pH is particularly advantageously lowered to values from 5 to 8 within 10 to 90 minutes. This is followed according to the invention by a maturing period, preferably a maturing period of approximately one hour. The temperatures should preferably not exceed 50° C. The aqueous suspension is then washed and dried. Possible methods for drying ultrafine, surface-modified titanium dioxide include spray-drying, freeze-drying and/or mill-drying, for example. Depending on the drying method, a subsequent milling of the dried powder may be necessary. Milling can be performed by methods known per se.

According to the invention the following compounds are particularly suitable as organic surface modifiers: polyethers, silanes, polysiloxanes, polycarboxylic acids, fatty acids, polyethylene glycols, polyesters, polyamides, polyalcohols, organic phosphonic acids, titanates, zirconates, alkyl and/or aryl sulfonates, alkyl and/or aryl sulfates, alkyl and/or aryl phosphoric acid esters.

Organically surface-modified titanium dioxide can be produced by methods known per se. One option is surface modification in an aqueous or solvent-containing phase. Alternatively the organic component can be applied to the surface of the particles by direct spraying followed by mixing/milling.

According to the invention suitable organic compounds are added to a titanium dioxide suspension whilst stirring vigorously and/or during a dispersion process. During this process the organic modifications are bound to the particle surface by chemisorption/physisorption.

Suitable organic compounds are in particular compounds selected from the group of alkyl and/or aryl sulfonates, alkyl and/or aryl sulfates, alkyl and/or aryl phosphoric acid esters or mixtures of at least two of these compounds, wherein the alkyl or aryl radicals can be substituted with functional groups. The organic compounds can also be fatty acids, optionally having functional groups. Mixtures of at least two such compounds can also be used.

The following can be used by way of example: alkyl sulfonic acid salt, sodium polyvinyl sulfonate, sodium-N-alkyl benzenesulfonate, sodium polystyrene sulfonate, sodium dodecyl benzenesulfonate, sodium lauryl sulfate, sodium cetyl sulfate, hydroxylamine sulfate, triethanol ammonium lauryl sulfate, phosphoric acid monoethyl monobenzyl ester, lithium perfluorooctane sulfonate, 12-bromo-1-dodecane sulfonic acid, sodium-10-hydroxy-1-decane sulfonate, sodium-carrageenan, sodium-10-mercapto-1-cetane sulfonate, sodium-16-cetene(1) sulfate, oleyl cetyl alcohol sulfate, oleic acid sulfate, 9,10-dihydroxystearic acid, isostearic acid, stearic acid, oleic acid.

The organically modified titanium dioxide can either be used directly in the form of the aqueous paste or can be dried before use. Drying can be performed by methods known per se. Suitable drying options are in particular the use of convection-dryers, spray-dryers, mill-dryers, freeze-dryers and/or pulse-dryers. Other dryers can also be used according to the invention, however. Depending on the drying method, a subsequent milling of the dried powder may be necessary. Milling can be performed by methods known per se.

According to the invention the surface-modified titanium dioxide particles optionally have one or more functional groups, for example one or more hydroxyl, amino, carboxyl, epoxy, vinyl, methacrylate and/or isocyanate groups, thiols, alkyl thiocarboxylates, di- and/or polysulfide groups.

Surface modifiers which are bound to the titanium dioxide particles by one functional group and which interact with the polymer matrix via another functional group are preferred.

The surface modifiers can be chemically and/or physically bound to the particle surface. The chemical bond can be covalent or ionic. Dipole-dipole or van der Waals bonds are possible as physical bonds. The surface modifiers are preferably bound by means of covalent bonds or physical dipole-dipole bonds.

According to the invention the surface-modified titanium dioxide particles have the ability to form a partial or complete chemical and/or physical bond with the polymer matrix via the surface modifiers. Covalent and ionic bonds are suitable as chemical bond types. Dipole-dipole and van der Waals bonds are suitable as physical bond types.

In order to produce the composite according to the invention a masterbatch can preferably be produced first, which preferably contains 5 to 80 wt. % of titanium dioxide. This masterbatch can then either be diluted with the crude polymer only or mixed with the other constituents of the formulation and optionally dispersed again.

In order to produce the composite according to the invention a method can also be chosen wherein the titanium dioxide is first incorporated into organic substances, in particular into amines, polyols, styrenes, formaldehydes and moulding compositions thereof, vinyl ester resins, polyester resins or silicone resins, and dispersed. These organic substances with added titanium dioxide can then be used as the starting material for production of the composite.

Conventional dispersing methods, in particular using melt extruders, high-speed mixers, triple roll mills, ball mills, bead mills, submills, ultrasound or kneaders, can be used to disperse the titanium dioxide in the masterbatch. The use of submills or bead mills with bead diameters of d<1.5 mm is particularly advantageous.

The composite according to the invention surprisingly has outstanding mechanical and tribological properties. In comparison to the unfilled polymer the composites according to the invention have markedly improved values for flexural modulus, flexural strength, tensile modulus, tensile strength, crack toughness, fracture toughness, impact strength and wear rates.

The invention provides in detail:
Composites consisting of at least one elastomer and/or at least one thermoset and a precipitated, surface-modified titanium dioxide, whose crystallite size d₅₀ is less than 350 nm, preferably less than 200 nm and particularly preferably between 3 and 50 nm, and wherein the titanium dioxide can be both inorganically and/or organically surface-modified (hereinafter also referred to as titanium dioxide composites);
Titanium dioxide composites, wherein an unsaturated polyester resin (UP), a phenolic resin, a melamine resin, a formaldehyde moulding composition, a vinyl ester resin, a diallyl phthalate resin or a urea resin, preferably a UP resin, is used as the thermoset;
Titanium dioxide composites, wherein natural rubber (NR), isoprene rubber (IR), butyl rubber (CIIR, BIIR), butadiene rubber (BR), styrene-butadiene rubber (SBR), acrylonitrile-butadiene rubber (NBR), bromobutyl rubber (BIIR), styrene-butadiene-isoprene rubber (SBIR), chloroprene rubber (CR), chlorosulfonated polyethylene rubber (CSM), hydrogenated NBR rubber (HNBR), polymethylsiloxane-vinyl rubber (VMQ), acrylate-ethylene rubber (AEM), acrylate rubber (ACM), fluoro rubber (FKM), fluorosilicone rubber (FVMQ), thermoplastic elastomers (TPE), thermoplastic elastomers (TPE) based on polyamide (TPA), based on copolyesters (TPC), based on olefins (TPO), based on styrene (TPS), based on polyurethane (TPU), based on vulcanised rubber (TPV) or mixtures of at least two of these plastics are used as the elastomer;
Titanium dioxide composites, wherein the composite contains 20 to 99.8 wt. % of thermoset, 0.1 to 60 wt. % of precipitated, surface-modified titanium dioxide, 0 to 80 wt. % of mineral filler and/or glass fibre, 0.05 to 10 wt. % of process additives, 0 to 10 wt. % of pigment and 0 to 40 wt. % of aluminium hydroxide;
Titanium dioxide composites, wherein the composite contains 100 phr of elastomer, 0.1 to 300 phr of precipitated, surface-modified titanium dioxide, 0 to 10 phr of vulcanisation accelerator, 0 to 10 phr of vulcanisation retarder, 0 to 20 phr of zinc oxide, 0 to 10 phr of stearic acid, 0 to 20 phr of sulfur and/or peroxide, 0 to 300 phr of mineral filler, 0 to 200 phr of plasticiser, 0 to 30 phr of protective systems, preferably containing antioxidants and anti-ozonants;
Titanium dioxide composites, wherein the proportion of precipitated, surface-modified titanium dioxide in the composite is 0.1 to 60 wt. %, preferably 0.5 to 30 wt. %, particularly preferably 1.0 to 20 wt. %;
Titanium dioxide composites, wherein the inorganic surface modification of the ultrafine titanium dioxide consists of a compound containing at least two of the following elements: aluminium, antimony, barium, calcium, cerium, chlorine, cobalt, iron, phosphorus, carbon, manganese, oxygen, sulfur, silicon, nitrogen, strontium, vanadium, zinc, tin and/or zirconium compounds or salts. Sodium silicate, sodium aluminate and aluminium sulfate are cited by way of example;
Titanium dioxide composites, wherein the organic surface modification consists of one or more of the following constituents: polyethers, silanes, siloxanes, polysiloxanes, polycarboxylic acids, polyesters, polyamides, polyethylene glycols, polyalcohols, fatty acids, preferably unsaturated fatty acids, polyacrylates, organic phosphonic acids, titanates, zirconates, alkyl and/or aryl sulfonates, alkyl and/or aryl sulfates, alkyl and/or aryl phosphoric acid esters;
Titanium dioxide composites, wherein the surface modification contains one or more of the following functional groups: hydroxyl, amino, carboxyl, epoxy, vinyl, methacrylate, and/or isocyanate groups, thiols, alkyl thiocarboxylates, di- and/or polysulfide groups;
Titanium dioxide composites, wherein the surface modification is covalently bound to the particle surface;
Titanium dioxide composites, wherein the surface modification is ionically bound to the particle surface;
Titanium dioxide composites, wherein the surface modification is bound to the particle surface by means of physical interactions;
Titanium dioxide composites, wherein the surface modification is bound to the particle surface by means of a dipole-dipole or van der Waals interaction;
Titanium dioxide composites, wherein the surface-modified titanium dioxide particles bond with the polymer matrix;
Titanium dioxide composites, wherein there is a chemical bond between the titanium dioxide particles and the polymer matrix;
Titanium dioxide composites, wherein the chemical bond between the titanium dioxide particles and the polymer matrix is a covalent and/or ionic bond;
Titanium dioxide composites, wherein there is a physical bond between the titanium dioxide particles and the polymer matrix;
Titanium dioxide composites, wherein the physical bond between the titanium dioxide particles and the polymer matrix is a dipole-dipole bond (Keeson), an induced dipole-dipole bond (Debye) or a dispersive bond (van der Waals);
Titanium dioxide composites, wherein there is a physical and chemical bond between the titanium dioxide particles and the polymer matrix;
Method for producing the titanium dioxide composites;
Method for producing the titanium dioxide composites, wherein a masterbatch is produced first and the titanium dioxide composite is obtained by diluting the masterbatch with the crude polymer, the masterbatch containing 5 to 80 wt. % of titanium dioxide, preferably 15 to 60 wt. % of titanium dioxide;
Method for producing the titanium dioxide composites, wherein the titanium-dioxide-containing masterbatch is diluted with the crude polymer and a dispersion preferably follows;
Method for producing the titanium dioxide composites, wherein the masterbatch is mixed with the other constituents of the formulation in one or more steps and a dispersion preferably follows;
Method for producing the titanium dioxide composites, wherein the titanium dioxide is first incorporated into organic substances, in particular into amines, polyols, styrenes, formaldehydes and moulding compositions thereof, vinyl ester resins, polyester resins or silicone resins, and dispersed.
Method for producing the titanium dioxide composites, wherein the organic substances with added titanium dioxide are used as the starting material for production of the composite;
Method for producing the titanium dioxide composites, wherein dispersion of the titanium dioxide in the masterbatch is performed using conventional dispersing methods, in particular using melt extruders, high-speed mixers, triple roll mills, ball mills, bead mills, submills, ultrasound or kneaders;
Method for producing the titanium dioxide composites, wherein submills or bead mils are preferably used to disperse the titanium dioxide;
Method for producing the titanium dioxide composites, wherein bead mills are preferably used to disperse the titanium dioxide, the beads preferably having diameters of d<1.5 mm, particularly preferably d<1.0 mm, most particularly preferably d<0.3 mm;
Titanium dioxide composites having improved mechanical properties and improved tribological properties;
Titanium dioxide composites, wherein both the strength and the toughness are improved through the use of surface-modified titanium dioxide particles;
Titanium dioxide composites, wherein the improvement in the strength and toughness can be observed in a flexural test or a tensile test;
Titanium dioxide composites having improved impact strength and/or notched impact strength values;
Titanium dioxide composites, wherein the wear resistance is improved by the use of surface-modified titanium dioxide particles;
Titanium dioxide composites, wherein the scratch resistance is improved by the use of surface-modified titanium dioxide particles;
Titanium dioxide composites, wherein the stress cracking resistance is improved by the use of surface-modified titanium dioxide particles;
Titanium dioxide composites, wherein an improvement in the creep resistance can be observed;
Titanium dioxide composites, wherein the viscoelastic properties, characterised by the loss factor tan δ, are improved;
Use of the titanium dioxide composites for components for the automotive or aerospace sector, in particular for the purposes of weight reduction, for example in the form of bumpers or interior trim;
Use of the titanium dioxide composites, in particular in the form of seals or vibration dampers.

The invention is illustrated by means of the examples below, without being limited thereto.

### EXAMPLE 1

The organically post-treated and surface-modified titanium dioxide is dispersed in the UP resin Palapreg P17-02 in a concentration of 25 wt. % using a bead mill until the fineness measured on a Hegmann gauge is less than 5 μm.

The inorganically post-treated and surface-modified titanium dioxide can be produced in the following way, for example:

3.7 kg of a 6.5 wt. % aqueous suspension of ultrafine titanium dioxide particles having average primary particle diameters d₅₀ of 14 nm (result of TEM analyses) are heated to a temperature of 40° C. whilst stirring. The pH of the suspension is adjusted to 12 using 10% sodium hydroxide solution. 14.7 ml of an aqueous sodium silicate solution (284 g SiO₂/l), 51.9 ml of an aluminium sulfate solution (with 75 g Al₂O₃/I) and 9.7 ml of a sodium aluminate solution (275 g Al₂O₃/I) are added simultaneously to the suspension whilst stirring vigorously and keeping the pH at 12.0. The suspension is homogenised for a further 10 minutes whilst stirring vigorously. The pH is then slowly adjusted to 7.5, preferably within 60 minutes, by adding a 5% sulfuric acid. This is followed by a maturing time of 10 minutes, likewise at a temperature of 40° C. The reaction suspension is filtered and the resulting filter cake is washed with demineralised water to a conductivity of less than 100 μS/cm. This filter cake is dispersed to produce a suspension having a solids content of 20 wt. %. 15 g of 3-methacryloxypropyl-trimethoxysilane are added slowly to the suspension whilst dispersing with the high-speed mixer. The suspension is then dispersed with the high-speed mixer for a further 20 minutes and dried in a spray-dryer.

TABLE 1
Formulation for glass fibre-reinforced plastics based on UP resin

| | | | | Material |
|---|---|---|---|---|
| Reactant | Manufacturer | | | weight [g] |
| Palapreg P17-02* | BASF | 70% | | 31.08* |
| Palapreg H814-01 | DSM Composite Resins | 30% | | 13.32 |
| BYK W996 | BYK-Chemie GmbH | 1.5 | phr | 0.67 |
| BYK P9060 | BYK-Chemie GmbH | 4 | phr | 1.78 |
| Trigonox C | Akzo Nobel | 1.5 | phr | 0.67 |
| Coathylene HA 1681 | Du Pont Polymer | 1.5 | phr | 0.67 |
| | Powders | | | |
| Luvatol MV 35 NV | Lehmann & Voss & Co | 3 | phr | 1.33 |
| Millicarb OG | Omya GmbH | 50 | phr | 22.20 |
| Martinal ON 921 | Martinswerk GmbH | 120 | phr | 53.29 |

| | | | |
|---|---|---|---|
| Surface-modified | Sachtleben Chemie | 8.3% | 10.36* |
| titanium dioxide* | GmbH | | |
| Glass fibres | Saint-Gobain Vetrolex | 25% | 33.84 |

*as a ready-to-use dispersion after bead grinding, weighed as a total weight of 41.44 g (Palapreg P17-02 + surface-modified titanium dioxide)

This dispersion based on the material weights specified in Table 1 is stirred with the additional resin Palapreg H814-01 and the additives in a high-speed mixer (mixer disc: diameter 30 mm) at 1500 rpm in a 180 ml plastic beaker and the necessary amount of fillers is added slowly whilst increasing the speed. On completion of the addition of fillers, the mixture is dispersed for 3 minutes at 6500 rpm.

The necessary amount of glass fibres is added to the crude composition and folded in with the aid of a spatula. This mixture is homogenised in a kneader for a further 3 minutes at 50 rpm. The resulting composition is carefully spread into a mould, which is impregnated with release agent and has 12 recesses measuring 80×15×4 mm³, and the surface is smoothed. The lower press platen of the mould is a Teflon plate, the upper press platen is a polished, chrome-plated metal plate. These three plates together with the protective paper are introduced into the press, which has been pre-heated to 150° C., and heated for one minute at 150° C. (with the press closed under normal pressure) and then the plates are press-moulded under a pressure of 100 bar at 150° C. After press-moulding the plates are left to cool and the specimens are pushed out of the mould.

### EXAMPLE 2

The specimens from Example 1 are examined in 3-point bending tests as defined in DIN EN ISO 178 and in impact strength tests as defined in DIN EN ISO 179. The results are set out in Table 2.

The composites according to the invention exhibit greatly improved properties in comparison to the pure resin.

TABLE 2
Mechanical properties of the prepared specimens

| | | Max. | | Rel. | |
|---|---|---|---|---|---|
| | Elastic | flexural | Breaking | elongation | Impact |
| | modulus | stress | stress | at break | strength |
| Sample | [MPa] | [MPa] | [MPa] | [%] | [kJ/m²] |
| Composite with- | 11759 | 66.51 | 39.66 | 0.84 | 8.77 |
| out titanium | | | | | |
| dioxide | | | | | |
| Composite with | 12124 | 67.48 | 41.28 | 0.77 | 9.97 |
| 8.3% titanium | | | | | |
| dioxide | | | | | |
| BMC with 8.3% | 12700 | 85.00 | 66.37 | 0.94 | 9.94 |
| silanised (3% | | | | | |
| silane) titanium | | | | | |
| dioxide | | | | | |
| BMC with 8.3% | 13630 | 91.18 | 75.92 | 0.96 | 10.03 |
| silanised (10% | | | | | |
| silane) titanium | | | | | |
| dioxide | | | | | |

1-23. (canceled)

24. A composite comprising a filler and a pigment in a polymer matrix, wherein the composite contains titanium dioxide having a crystallite size, at least one of an elastomer or a thermoset, wherein the crystallite size of the titanium dioxide d₅₀ is less than 350 nm, and wherein the titanium dioxide is at least one of inorganically surface modified or organically surface-modified.

25. A composite according to claim 24, wherein the thermoset comprises at least one of an unsaturated polyester resin, a phenolic resin, a melamine resin, a formaldehyde molding composition, a vinyl ester resin, a diallyl phthalate resin, a silicone resin and an urea resin.

26. A composite according to claim 24, wherein the elastomer comprises at least one member selected from the group consisting of natural rubber, isoprene rubber, butyl rubber, butadiene rubber, styrene-butadiene rubber, acrylonitrile-butadiene rubber, bromobutyl rubber, styrene-butadiene-isoprene rubber, chloroprene rubber, chlorosulfonated polyethylene rubber, hydrogenated acrylonitrile-butadiene rubber, polymethylsiloxane-vinyl rubber, acrylate-ethylene rubber, acrylate rubber, fluoro rubber, fluorosilicone rubber, a thermoplastic elastomer, a thermoplastic elastomer based on polyamide, a thermoplastic elastomer based on a copolyester, a thermoplastic elastomer based on an olefin, a thermoplastic elastomer based on styrene, a thermoplastic elastomer based on polyurethane and a thermoplastic elastomer based on vulcanized rubber.

27. A composite according to claim 24, wherein the composite contains 20 to 99.8 wt. % of thermoset, 0.1 to 60 wt. % of titanium dioxide, 0 to 80 wt. % of mineral filler or glass fiber, 0.05 to 10 wt. % of process additives, 0 to 10 wt. % of pigment and 0 to 40 wt. % of aluminum hydroxide.

28. A composite according to claim 24, comprising 100 phr of elastomer, 0.1 to 300 phr of titanium dioxide, 0 to 10 phr of vulcanization accelerator, 0 to 10 phr of vulcanization retarder, 0 to 20 phr of zinc oxide, 0 to 10 phr of stearic acid, 0 to 20 phr of sulfur and/or peroxide, 0 to 300 phr of mineral filler, 0 to 200 phr of plasticizer, 0 to 30 phr of a protective system.

29. A composite according to claim 24, wherein the proportion of titanium dioxide in the composite is 0.1 to 60 wt. %.

30. A composite according to claim 24, wherein the titanium dioxide is surface-modified with at least one of an inorganic compound or an organic compound.

31. A composite according to claim 30, wherein the percentage by weight of inorganic compounds relative to titanium dioxide is 0.1 to 50.0 wt. %.

32. A composite according to claim 30, wherein the inorganic compound comprises at least one member selected from the group consisting of aluminum, antimony, barium, calcium, cerium, chlorine, cobalt, iron, phosphorus, carbon, manganese, oxygen, sulfur, silicon, nitrogen, strontium, vanadium, zinc, tin and zirconium, or a salt thereof.

33. A composite according to claim 30, wherein the organic compound is selected from the group consisting of a silane, a siloxane, a polysiloxane, a polycarboxylic acid, a polyester, a polyether, a polyamide, a polyethylene glycol, a polyalcohol, a fatty acid, a polyacrylate, an organic phosphonic acid, a titanate, a zirconate, an alkyl sulfonate, an aryl sulfonate, an alkyl sulfate. an aryl sulfate, an alkyl phosphoric acid ester and an aryl phosphoric acid ester.

34. A composite according to claim 33, wherein the surface modification contains at least one functional group selected from the group consisting of hydroxyl, amino, carboxyl, epoxy, vinyl, methacrylate, an isocyanate, a thiol, an alkyl thiocarboxylate, disulfide and a polysulfide.

35. A composite according to claim 34, wherein the surface-modified titanium dioxide particles bond with the polymer matrix.

36. A composite according to claim 24, wherein the titanium dioxide particles have a primary particle size d₅₀ of less than or equal to 0.1 μm.

37. A method for producing a composite according to claim 24, wherein a masterbatch is produced from the titanium dioxide and part of the crude polymer and the composite is obtained by diluting the masterbatch with the crude polymer and dispersing therein.

38. A method according to claim 37, wherein a masterbatch is produced from the titanium dioxide and part of the crude polymer and the composite is obtained by diluting the masterbatch with the crude polymer, wherein the masterbatch contains 5 to 80 wt. % of titanium dioxide.

39. A method according to claim 37, wherein the masterbatch is mixed with the other constituents of the formulation in one or more steps to form a dispersion.

40. A method according to claim 37, wherein the titanium dioxide is first incorporated into an organic substance selected from the group consisting of an amine, a polyol, a styrene, a formaldehyde, a molding composition thereof, a vinyl ester resin, a polyester resin or a silicone resin, and dispersed therein.

41. A method according to claim 40, wherein the organic substance with the added titanium dioxide are provided as a starting material for production of the composite.

42. A method according to claim 37, wherein he titanium dioxide is dispersed in the masterbatch or in an organic substance with a melt extruder, an high-speed mixer, a triple roll mill, a ball mill, a bead mill, a submill, ultrasound or a kneader.

43. A method according to claim 42, wherein dispersion of the titanium dioxide is preferably performed in the submill or the bead mill.

44. A method according to claim 42, wherein dispersion of the titanium dioxide is performed in bead mills, wherein the bead have a diameter d<1.5 mm.

45. An automotive or aerospace part comprising the composite of claim 24.

46. A seal or a vibration damper comprising the composite of claim 24.
